(19) United States
(12) Patent Application Publication
(10) Pub. No.: US 2012/0128184 A1
(43) Pub. Date: May 24, 2012

(54) DISPLAY APPARATUS AND SOUND CONTROL METHOD OF THE DISPLAY APPARATUS

(75) Inventors: Hee-su KIM, Suwon-si (KR); Nam-hyun PARK, Suwon-si (KR)

(73) Assignee: SAMSUNG ELECTRONICS CO., LTD., Suwon-si (KR)

(21) Appl. No.: 13/162,223

(22) Filed: Jun. 16, 2011

(30) Foreign Application Priority Data
Nov. 18, 2010 (KR) 10-2010-0114771

(51) Int. Cl. H04R 5/02

(52) U.S. Cl. 381/306

(57) ABSTRACT

A display apparatus and a sound control method of the display apparatus are provided. The display apparatus includes: a display unit which displays an image thereon; a sound processor which processes an audio signal corresponding to the image displayed on the display unit and outputs the signal as a left audio signal and a right audio signal; a sensor which detects a viewing direction of a user watching the display unit; and a controller which controls the sound processor to individually adjust an extent of the left audio signal and an extent of the right audio signal corresponding to the viewing direction. With this configuration, there are provided a display apparatus which outputs a sound to optimize effects of a three-dimensional (3D) image, and a sound control method of the same.

### CROSS-REFERENCE TO RELATED APPLICATION

This application claims priority from Korean Patent Application No. 10-2010-0114771, filed on Nov. 18, 2010 in the Korean Intellectual Property Office, the disclosure of which is incorporated herein by reference.

### BACKGROUND

1. Field

Apparatuses and methods consistent with the exemplary embodiments relate to a display apparatus and a sound control method of the same, and more particularly, to a display apparatus to display a three-dimensional image and a sound control method of the same.

2. Description of the Related Art

With recent technological developments, display apparatuses display stereoscopic images that are not only two-dimensional (2D), but also three-dimensional (3D) image signals, and a user easily views stereoscopic images through accessible monitors or televisions (TVs).

To emphasize the liveliness of images, particularly 3D images, there is a demand for a distinguished service of not only images but sounds in order to optimize the liveliness provided from contents, such as movies, performances, or the like.

### SUMMARY

Accordingly, one or more exemplary embodiments provide a display apparatus which outputs a sound to optimize effects of a three-dimensional (3D) image, and a sound control method of the display apparatus.

Another exemplary embodiment provides a display apparatus which outputs a sound which varies dynamically based on a viewing direction or a movement of a user, and a sound control method of the display apparatus.

The foregoing and/or other aspects may be achieved by providing a display apparatus including: a display unit which displays an image thereon; a sound processor which processes an audio signal corresponding to the image displayed on the display unit and outputs the signal as a left audio signal and a right audio signal; a sensor which detects a viewing direction of a user watching the display unit; and a controller which controls the sound processor to individually adjust an extent of the left audio signal and an extent of the right audio signal corresponding to the viewing direction.

The sound processor may adjust an extent of an audio signal corresponding to an inclining direction to be smaller than an extent of an audio signal corresponding to an opposite direction when the viewing direction inclines to a right or left with respect to the display unit.

The signal processor may decrease an extent of an audio signal corresponding to a moving direction and increase an extent of an audio signal corresponding to a direction opposite to the moving direction when the viewing direction is moved to a left side or a right side with respect to the display unit.

The sensor may further detect a position of the user, and the sound processor may increase an extent of an audio signal corresponding to a moving direction of the user and decrease an extent of an audio signal corresponding to a direction opposite to the moving direction when the position of the user is detected to be moved.

The sensor may further detect a position of the user, and the sound processor may adjust the extent of the left audio signal and the extent of the right audio signal in reverse proportionate to a distance from the display unit to the user.

The sensor may further detect a position of the user, the sound processor may adjust the extent of the right audio signal to be louder than the extent of the left audio signal when the position of the user is detected to be right from a center of the display unit, and the sound processor may adjust the extent of the left audio signal to be louder than the extent of the right audio signal when the position of the user is detected to be left from the center of the display unit.

The sound processor may separate the audio signal into a main sound corresponding to a particular frequency band and a sub-sound excluding the main sound from the audio signal, and the controller may control the sound processor to adjust a volume of the main sound included in the left audio signal and the right audio signal.

The display unit may display three-dimensional (3D) images thereon, the display apparatus may further include shutter glasses including shutters which open and shut in correspondence with the 3D image, and the sensor may be installed in the shutter glasses.

The display apparatus may further include a left sound output unit to output the left audio signal and a right sound output unit to output the right audio signal.

The display unit may display a 3D image thereon, the display apparatus may further include shutter glasses including shutters which open and shut in correspondence with the 3D image, and the left sound output unit and the right sound output unit may be installed in the shutter glasses.

The foregoing and/or other aspects may be achieved by providing a sound control method of a display apparatus including a display unit to display an image, the method including: detecting a viewing direction of a user watching the display unit; and individually adjusting an extent of a left audio signal and an extent of a right audio signal based on the detected viewing direction of the user.

The adjusting may adjust an extent of an audio signal corresponding to an inclining direction to be smaller than an extent of an audio signal corresponding to a direction opposite to the inclining direction when the viewing direction is detected to incline to a right side or a left side with respect to the display unit.

The adjusting may decrease an extent of an audio signal corresponding to a moving direction and increase an extent of an audio signal corresponding to a direction which is opposite to the moving direction when the viewing direction is detected to be moved to a left side or a right side with respect to the display unit.

The method may further include detecting a position of the user, and the adjusting may increase an extent of an audio signal corresponding to a moving direction of the user and decrease an extent of an audio signal corresponding to a direction opposite to the moving direction when the position of the user is detected to be moved.

The method may further include detecting a position of the user, and the adjusting may adjust the extent of the right audio signal to be louder than the extent of the left audio signal when the position of the user is detected to be right from a center of the display unit, and the adjusting may adjust the extent of the left audio signal to be louder than the extent of the right audio signal when the position of the user is detected to be left from the center of the display unit.

As described above, according to exemplary embodiments, there are provided a display apparatus which outputs a sound to optimize effects of a three-dimensional (3D) image, and a sound control method of the same.

Further, according to exemplary embodiments, there are provided a display apparatus which outputs a sound which varies dynamically based on a viewing direction or a movement of a user, and a sound control method of the same.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of a display apparatus according to an exemplary embodiment.

FIGS. 2A and 2B illustrate an extent of an audio signal based on a viewing direction of a display apparatus according to an exemplary embodiment.

FIG. 3 illustrates an extent of an audio signal based on a movement of a viewing direction with respect to a display apparatus according to an exemplary embodiment.

FIG. 4 illustrates an extent of an audio signal based on a movement of a user according to an exemplary embodiment.

FIG. 5 illustrates an extent of an audio signal based on a distance between a display apparatus and a user according to an exemplary embodiment.

FIG. 6 is a flowchart illustrating a sound control method of a display apparatus according to an exemplary embodiment.

FIG. 7 is a schematic view of a display apparatus according to another exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

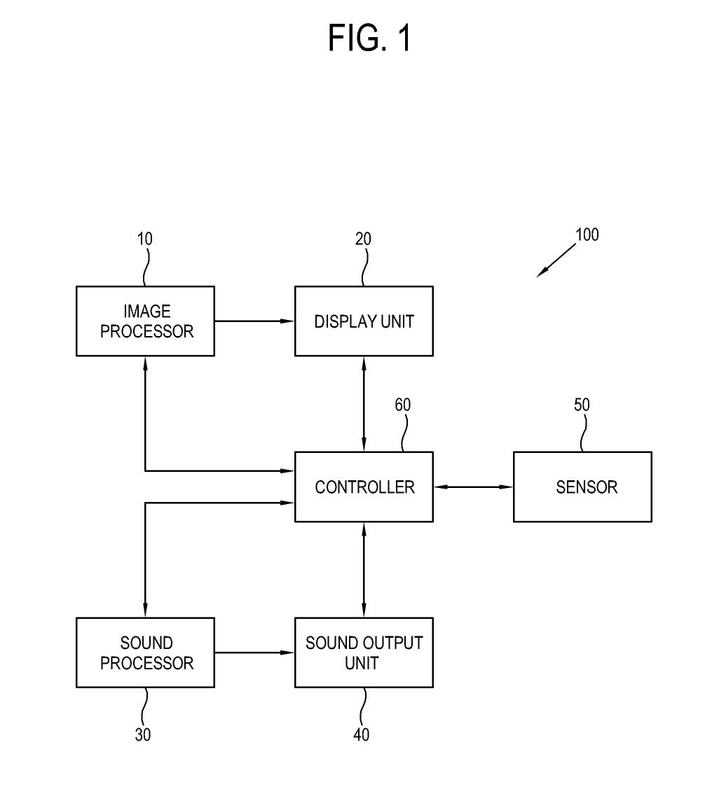

FIG. 1 is a block diagram of a display apparatus according to an exemplary embodiment. As shown in FIG. 1, the display apparatus 100 includes an image processor 10, a display unit 20, a sound processor 30, a sound output unit 40, a sensor 50, and a controller 60 to control the above components. The display apparatus 100 may be configured as a television processing and displaying a broadcasting signal, a home theater system including a television, a computer system including a monitor, or the like. The display apparatus 100 may receive a two-dimensional (2D) image signal, that is, a flat image signal, to display or receive a three-dimensional (3D) image signal, that is, a stereoscopic image signal, to display. Further, the display apparatus 100 may further include a signal receiver (not shown) to receive an image signal from an image source.

The image processor 10 separates a received 3D image into a left image and a right image and processes the left image and the right image to be alternately displayed on the display unit 20 based on a frame rate. Alternatively, the image processor 10 processes an input 2D image signal to be displayed on the display unit 20 or generates a left image and a right image using a 2D image signal. Further, the image processor 10 may perform image processing, such as demultiplexing, decoding, scaling, image quality adjustment, image quality enhancement, or the like.

The display unit 20 displays an image generated by the image processor 10. The display unit 20 may include a liquid crystal display (LCD) panel including a liquid crystal layer or an organic light emitting diode (OLED) panel including a light emitting layer of organic materials, and a panel driver to drive the panels. Alternatively, the display unit 20 may be configured as a screen to display an image projected from a projector.

A screen of the display unit 20 may have a curvature. When the display unit 20 is configured as the screen to display a projected image, the screen may include a curved surface. However, in the present exemplary embodiment, the display unit 20 includes a 2D screen, which is substantially flat, having a central area distinguished from right and left areas.

The sound processor 30 processes an audio signal corresponding to an image displayed on the display unit 20 to be output as a left audio signal and a right audio signal, and individually adjusts an extent of the left audio signal and an extent of the right audio signal. With development in sound processing, an audio signal may be output through a plurality of channels.

In the present exemplary embodiment, the sound processor 30 may output an audio signal, separated into a main sound corresponding to a particular frequency band and a sub-sound excluding the main sound from the audio signal. For example, the sound processor 30 may output a sound in a particular frequency band, such as a human voice and a sound of music, to a main sound channel and output other sounds to a sub-sound channel. A main audio signal may be included in either or both of the left audio signal and the right audio signal. When an audio signal is separated into a main sound and a sub-sound, the sound processor 30 may adjust a volume of the main sound and a volume of the sub-sound differently based on control by the controller 60.

The sound output unit 40 outputs a left audio signal and a right audio signal processed by the sound processor 30 so that a user can hear the signal. The sound output unit 40 may be configured as a speaker which eliminates noise of an audio signal and amplifies the signal to output. The sound output unit 40 may include a plurality of speakers based on channels of a sound, and may include a left sound speaker (not shown) to output a left audio signal and a right sound speaker (not shown) to output a right audio signal. The sound output unit 40 may be integrated with the display apparatus 100 or may be provided separately from a display main body displaying an image. The sound output unit 40 may not be included as a component of the display apparatus 100, and in this instance, the sound output unit 40 may be excluded from the scope of control of the display apparatus 100.

The sensor 50 detects a viewing direction of the user watching the display unit 20. The sensor 50 may be configured as a camera to pick up the eyes of the user or as a gyro sensor to detect a moving direction of the user's face. The sensor 50 may further detect a position of the user in front of the display unit 20, for example, whether the user is positioned on a right side of the display unit 20 or on a left side thereof, a distance from the display unit 20, or whether the user moves in a particular direction.

The controller 60 controls the sound processor 30 to individually adjust an extent of a left audio signal and an extent of a right audio signal corresponding to a detected viewing direction of the user. When a 3D image is displayed on the display unit 20, the user may feel as if the image is real. In the present exemplary embodiment, the controller 60 adjusts the extent of the left audio signal and the extent of the right audio signal differently based on the viewing direction of the user or the position of the user, to optimize the reality of the image. In this instance, the controller 60 may control the sound processor 30 to adjust a volume of a main sound included in the left audio signal and the right audio signal. A volume of a human voice, a particular instrument, or a particular sound important to the image is adjusted differently on the left and the right to increase effects of the 3D image.

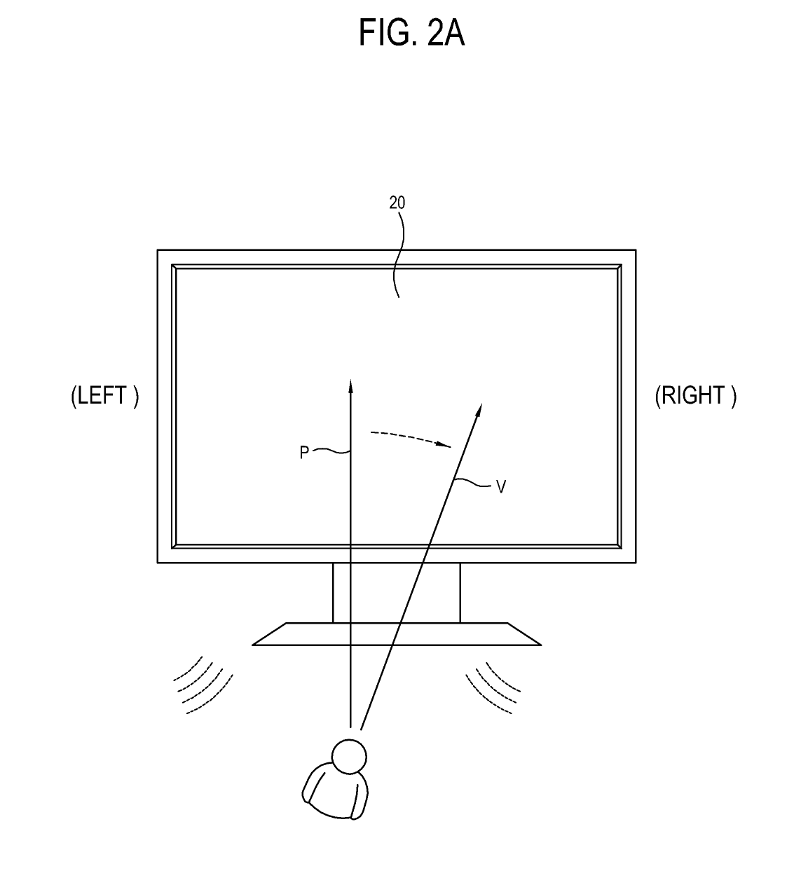

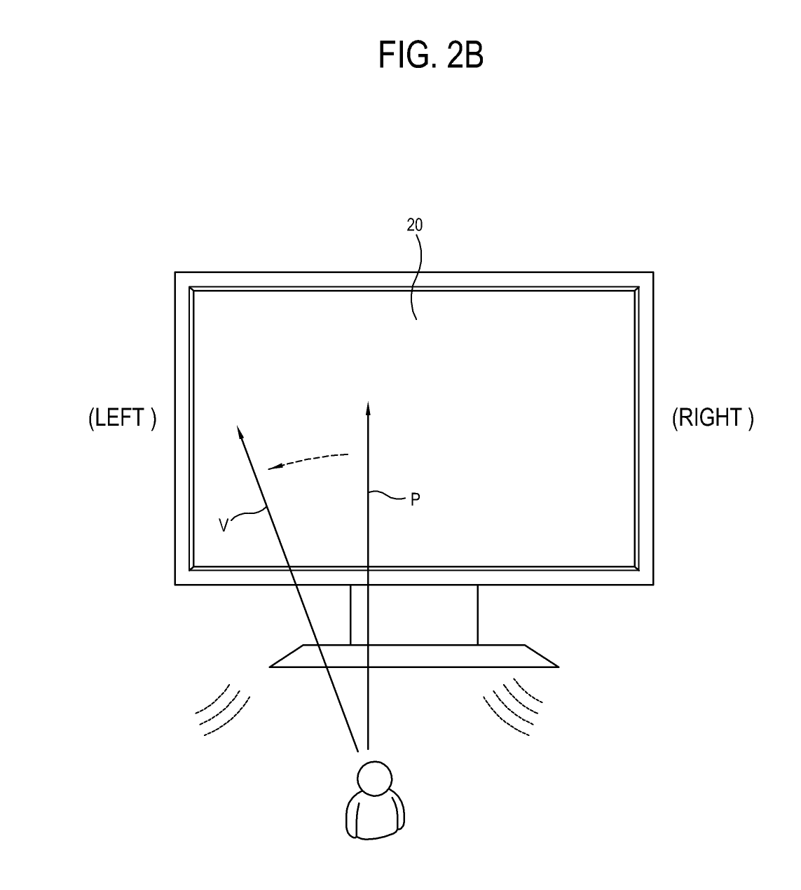

FIGS. 2A and 2B illustrate an extent of an audio signal based on a viewing direction with respect to a display apparatus according to an exemplary embodiment. FIG. 2A illustrates that a viewing direction V of the user inclines to the right side with respect to the display unit 20, and FIG. 2B illustrates that the viewing direction V of the user inclines to the left side with respect to the display unit 20. In the exemplary embodiments, the viewing direction V is defined to incline to the right side when a viewpoint of the user from which the user views the display unit 20 is changed to the right side from a direct front direction (P) in which the user views the display unit 20 when the user is positioned directly in front of the display unit. That the viewing angle V inclines to the right side denotes that the user's face looks toward the right side of the display unit 20, instead of directly to the front side. In this instance, a left ear of the user is closer to the display unit 20 than a right ear. The sound processor 30 adjusts the extent of the left audio signal heard through the left ear of the user to be louder than the extent of the right audio signal heard through the right ear.

On the contrary, when the viewing direction V of the user inclines to the left side with respect to the display unit 20, the left ear of the user becomes more distant from the display unit 20 than the right ear. The sound processor 30 thus adjusts the extent of the right audio signal heard through the right ear of the user to be louder than the extent of the left audio signal heard through the left ear.

The position of the user detected by the sensor 50 is detected to be right from a center of the display unit 20, the sound processor 30 adjusts the extent of the right audio signal to be louder than the extent of the left audio signal. When the position of the user is detected to be left from the center of the display unit 20, the sound processor 30 adjusts the extent of the left audio signal to be louder than the extent of the right audio signal. When the user is positioned on the right side from the center of the display unit 20, the viewing direction of the user may possibly incline to the left side with respect to the display unit 20, and accordingly the right ear may be closer to the display unit 20 than the left ear. Thus, the extent of the right audio signal is adjusted to be louder than the extent of the left audio signal. Further, when a user is positioned on the right side from the center of the display unit, a sound corresponding to the right audio signal is adjusted to be louder than a sound corresponding to the left audio signal, thereby providing stereophonic sound effects to the user.

On the contrary, when the user is positioned on the left side from the center of the display unit 20, the extent of the left audio signal is adjusted to be louder than the extent of the right audio signal.

Since sounds from the right and left sides, particularly, the human voice, are adjusted based on the viewing direction or the position of the user, the user may realistically enjoy an image displayed on the display unit 20. Moreover, the user may experience the feeling of hearing stereophonic sounds without having to use a plurality of speakers, as provided in a home theater system.

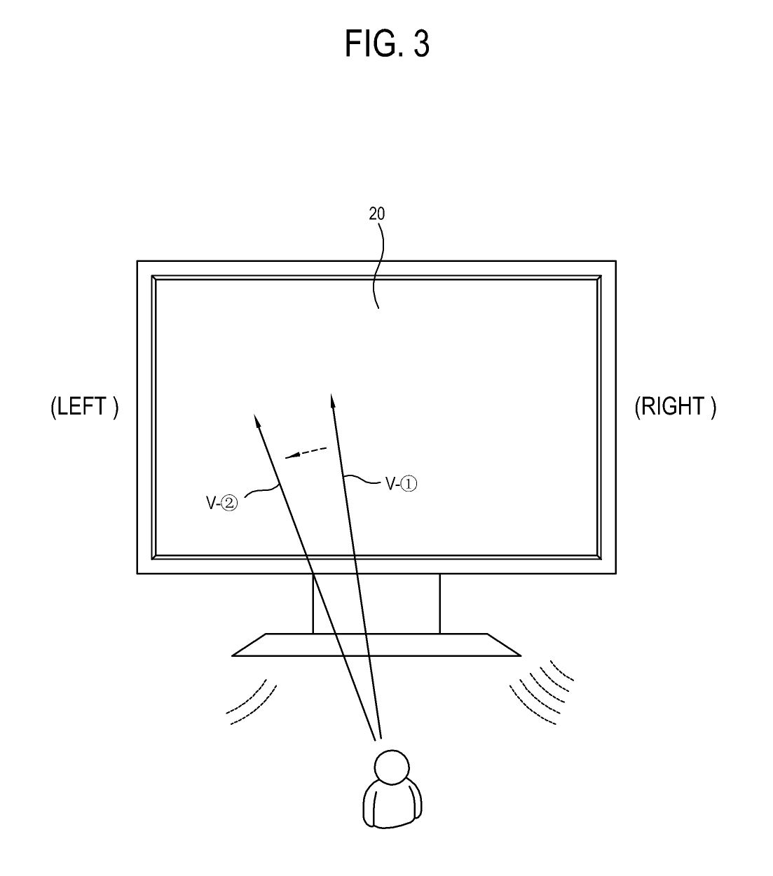

FIG. 3 illustrates an extent of an audio signal based on a movement of a viewing direction with respect to a display apparatus according to an exemplary embodiment.

As shown in FIG. 3, the user may change a current viewing direction V-\textcircled{1} to the right or left with respect to the display unit 20. The user may turn the head or change the viewpoint to view an interesting image.

Accordingly, the sound processor 30 decreases an extent of a sound corresponding to a changed viewing direction V-\textcircled{2} and increases an extent of an audio signal corresponding to an opposite direction. In FIG. 3, since the user changes the viewing direction to the left, from the direction V-\textcircled{1} to the direction V-\textcircled{2}, an extent of a left audio signal decreases and an extent of a right audio signal increases. The sound processor 30 may adjust the extent of the audio signals using various methods, such as increasing or decreasing an absolute volume of a sound currently being output or changing a difference in volume between the left audio signal and the right audio signal based on the viewing direction.

The display apparatus 100 may provide a realistic image as if being realized in front of the user by adjusting the extent of the audio signals corresponding to a subtle movement of the user.

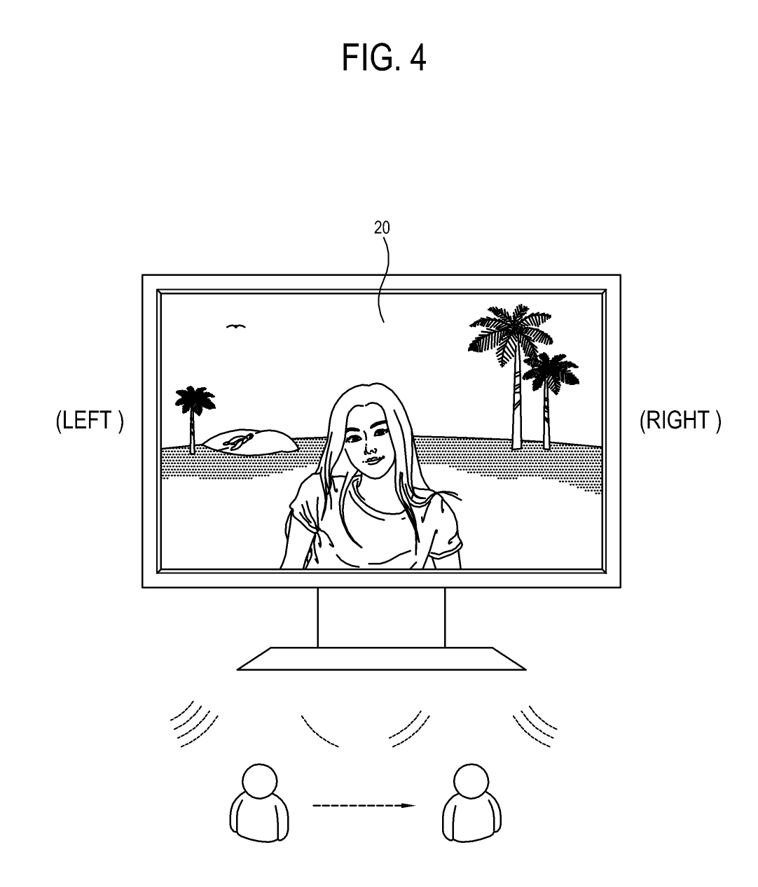

FIG. 4 illustrates an extent of an audio signal based on a movement of the user according to an exemplary embodiment.

When the user changes a position, not a viewpoint, in front of the display unit 20, the sensor 50 detects a change in the position of the user. The controller 60 controls the sound processor 30 to individually adjust the extent of the audio signal corresponding to the movement of the user.

The sound processor 30 increases an extent of an audio signal corresponding to a moving direction of the user and decreases an extent of a sound corresponding to a direction which is opposite to the moving direction. In FIG. 4, when the user moves from the left to the right on the display unit 20, an extent of a right audio signal increases whereas an extent of a left audio signal decreases. When the user moves from the right to the left, the extent of the left audio signal increases whereas the extent of the right audio signal decreases.

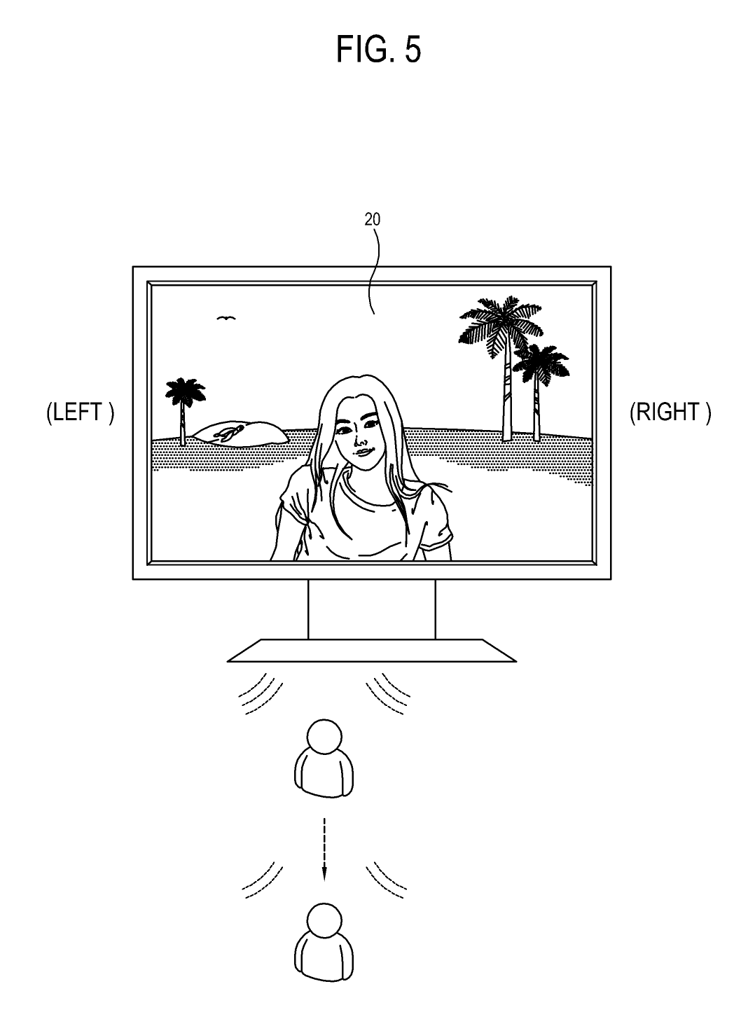

FIG. 5 illustrates an extent of an audio signal based on a distance between the display apparatus and the user according to an exemplary embodiment.

When the user is detected to become distant from the display unit 20, the controller 60 controls the sound processor 30 to adjust an extent of a left audio signal and an extent of a right audio signal in reverse proportionate to a distance from the display unit 20 to a position of the user. The sound control of the present exemplary embodiment may be added to the foregoing exemplary embodiments. An audio signal decreases when the user becomes distant from the display unit 20, while the audio signal increases when the user becomes closer to the display unit 20. The distance from the display unit 20 to the position of the user may be set as the most direct route from the position of the user to the display unit 20 or may be set as a distance from a particular spot of the display unit 20.

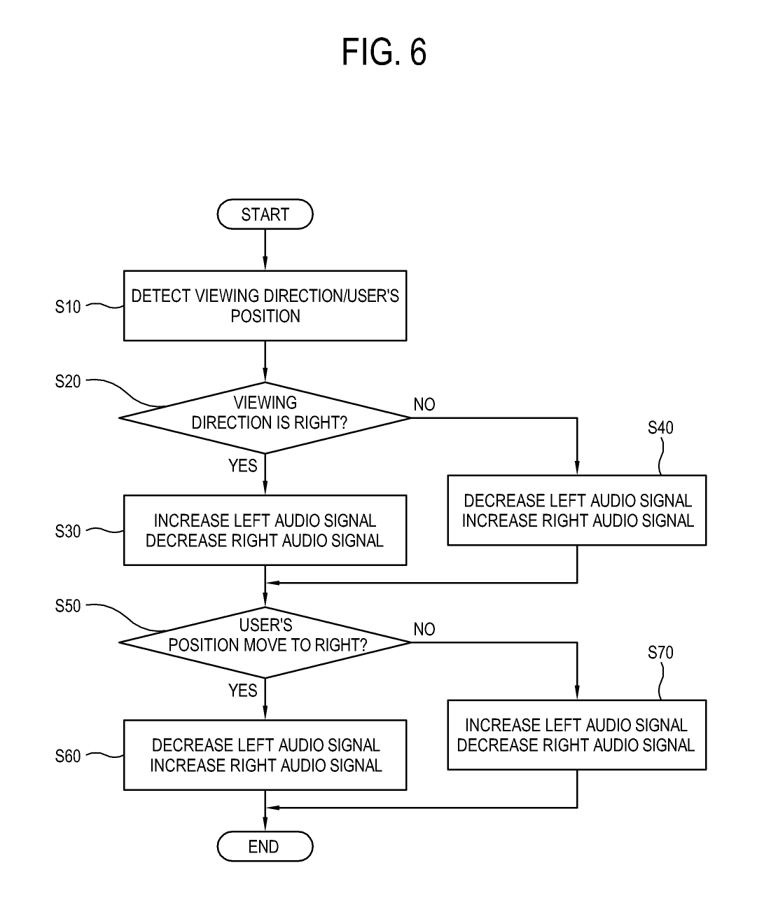

FIG. 6 is a flowchart illustrating a sound control method of the display apparatus according to an exemplary embodiment. The sound control method according to the present exemplary embodiment is described below with reference to FIG. 6.

First, at least one of a viewing direction and a position of the user watching the display unit 20 is detected (operation S10).

Before the viewing direction of the user is detected, a left audio signal and a right audio signal corresponding to an image are processed, and the left audio signal and the right audio signal are included in a main sound and a sub-sound.

When the viewing direction inclines or is moved with respect to the display unit 20, the controller 60 determines which direction the viewing angle inclines or is moved with respect to the display unit 20 (operation S20).

When the viewing direction inclines or is moved to the right with respect to the display unit 20, the sound processor 30 increases an extent of the left audio signal and decreases an extent of the right audio signal (operation S30).

On the contrary, when the viewing direction inclines or is moved to the left with respect to the display unit 20, the sound processor 30 increases the extent of the right audio signal and decreases the extent of the left audio signal (operation S40).

When the position of the user is detected to be moved, the controller 60 determines which direction the position of the user is moved with respect to the display unit 20 (operation S50).

When the position of the user is moved to the right with respect to the display unit 20, the sound processor increases the extent of the right audio signal and decreases the extent of the left audio signal (operation S60).

However, when the position of the user is moved to the left with respect to the display unit 20, the sound processor 30 increases the extent of the left audio signal and decreases the extent of the right audio signal (operation S70).

An audio signal control is applied when a corresponding event happens, and is not limited to the process described with reference to FIG. 6.

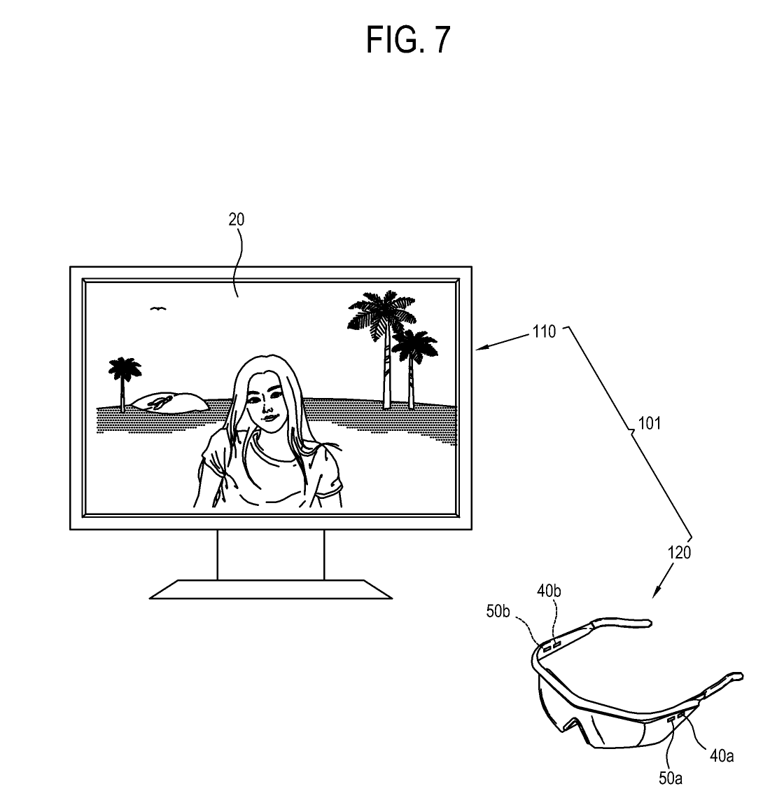

FIG. 7 is a schematic view of a display apparatus according to another exemplary embodiment.

The display apparatus 101 according to the present exemplary embodiment includes a display main body 110 including a display unit 20 to display an image and shutter glasses 120 including shutters which open and shut based on a 3D image displayed on the display unit 20.

The shutter glasses 120 include a left shutter and a right shutter, and the left shutter and the right shutter alternately open and shut based on a synchronization signal output from the display main body 110.

Further, the shutter glasses 120 may further include a left sound output unit 40a to output a left audio signal and a right sound output unit 40b to output a right audio signal. That is, the display apparatus 101 of the present exemplary embodiment may be configured to include the left sound output unit 40a and the right sound output unit 40b in the shutter glasses 120 to output audio signals to the ears of the user.

Alternatively, the left sound output unit 40a and the right sound output unit 40b may be configured as earphones, a headset, or the like, to transmit and receive data to and from the display main body 110 via wire-based or wireless methods.

In the present exemplary embodiment, sensors 50a and 50b may further be provided in the shutter glasses 120 to easily detect a movement of a viewing direction or a positional change of the user. Here, the sensors 50a and 50b include a gyro sensor, and detect and transmit a subtle movement of the user to the display main body 110. However, the type of sensor is not limited thereto.

As described above, the exemplary embodiments provide a display apparatus and a sound control method of the same which vary a volume of a sound based on a viewing direction or a position of a user in order to provide realistic and dynamic sounds.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a display unit which displays an image thereon;
a sound processor which processes an audio signal which corresponds to the image displayed on the display unit and outputs the audio signal as a left audio signal and a right audio signal;
a sensor which detects a viewing direction of a user watching the display unit; and
a controller which controls the sound processor to individually adjust an extent of the left audio signal and an extent of the right audio signal corresponding to the detected viewing direction.

2. The display apparatus of claim 1, wherein the sound processor adjusts an extent of an audio signal corresponding to an inclining direction to be smaller than an extent of an audio signal corresponding to a direction opposite to the inclining direction when the viewing direction inclines to a right side of the display unit or a left side of the display unit.

3. The display apparatus of claim 1, wherein the signal processor decreases an extent of an audio signal corresponding to the viewing direction of the user, and increases an extent of an audio signal corresponding to a direction opposite to the viewing direction of the user when the viewing direction is moved to a left side of the display unit or a right side of the display unit.

4. The display apparatus of claim 1, wherein the sensor further detects a position of the user, and the sound processor increases an extent of an audio signal corresponding to a moving direction of the user and decreases an extent of an audio signal corresponding to a direction opposite to the moving direction when the position of the user is detected to be moved.

5. The display apparatus of claim 1, wherein the sensor further detects a position of the user, and the sound processor adjusts the extent of the left audio signal and the extent of the right audio signal in reverse proportion to a distance from the display unit to the user.

6. The display apparatus of claim 1, wherein the sensor further detects a position of the user, the sound processor adjusts the extent of the right audio signal to be louder than the extent of the left audio signal when the position of the user is detected to be right from a center of the display unit, and the sound processor adjusts the extent of the left audio signal to be louder than the extent of the right audio signal when the position of the user is detected to be left from the center of the display unit.

7. The display apparatus of claim 1, wherein the sound processor separates the audio signal into a main sound which corresponds to a particular frequency band and a sub-sound which excludes the main sound from the audio signal, and the controller controls the sound processor to adjust a volume of the main sound included in the left audio signal and the right audio signal.

8. The display apparatus of claim 1, wherein the display unit displays a three-dimensional (3D) image, and further comprises shutter glasses which include shutters which open and shut in correspondence with the 3D image, wherein the sensor is installed in the shutter glasses.

9. The display apparatus of claim 1, further comprising a left sound output unit which outputs the left audio signal and a right sound output unit which outputs the right audio signal.

10. The display apparatus of claim 9, which displays a three-dimensional (3D) image on the display unit, and further comprises shutter glasses which include shutters which open and shut in correspondence with the 3D image, wherein the left sound output unit and the right sound output unit are installed in the shutter glasses.

11. A sound control method of a display apparatus comprising a display unit to display an image, the method comprising:
detecting a viewing direction of a user watching the display unit; and
individually adjusting an extent of a left audio signal and an extent of a right audio signal based on the detected viewing direction.

12. The method of claim 11, wherein the adjusting adjusts an extent of an audio signal corresponding to an inclining direction to be smaller than an extent of an audio signal corresponding to a direction opposite to the inclining direction when the viewing direction is detected to incline to a right side of the display unit or a left side of the display unit.

13. The method of claim 11, wherein the adjusting decreases an extent of an audio signal corresponding to a viewing direction of the user and increases an extent of an audio signal corresponding to a direction opposite to the viewing direction of the user when the viewing direction is detected to be moved to a left side of the display unit or a right side of the display unit.

14. The method of claim 11, further comprising detecting a position of the user, wherein the adjusting increases an extent of an audio signal corresponding to a moving direction of the user and decreases an extent of an audio signal corresponding to a direction opposite to the moving direction when the position of the user is detected to be moved.

15. The method of claim 11, further comprising detecting a position of the user, wherein the adjusting adjusts the extent of the right audio signal to be louder than the extent of the left audio signal when the position of the user is detected to be right from a center of the display unit, and the adjusting adjusts the extent of the left audio signal to be louder than the extent of the right audio signal when the position of the user is detected to be left from the center of the display unit.

16. A display apparatus comprising:
a sensor which senses a viewing direction of a user; and
a controller which controls a sound processor in the display apparatus to individually adjust an extent of a left audio signal and an extent of a right audio signal which corresponds to the sensing of the viewing direction of the user.

17. The display apparatus of claim 16, further comprising a display unit which displays an image.

18. The display apparatus of claim 17, further comprising a sound processor which processes an audio signal which corresponds to the image. displayed on the display unit and outputs the audio signal as a left audio signal and a right audio signal;

19. The display apparatus of claim 18, wherein the sensor further detects a position of the user, and the sound processor increases an extent of an audio signal corresponding to a moving direction of the user and decreases an extent of an audio signal corresponding to a direction opposite to the moving direction when the position of the user is detected to be moved.
